(19) United States
(12) Patent Application Publication
(10) Pub. No.: US 2006/0128197 A1
(43) Pub. Date: Jun. 15, 2006

(54) Board mounted power connector

(76) Inventors: Daniel B. McGowan, Naperville, IL (US); Steven B. Bogiel, Lisle, IL (US); Yan Margulis, Buffalo Grove, IL (US); Arvind Patel, Naperville, IL (US); Kenneth M. Stiles, Barrington, IL (US)

Correspondence Address: MOLEX INCORPORATED, 2222 WELLINGTON COURT, LISLE, IL, 60532, US

(21) Appl. No.: 11/010,226

(22) Filed: Dec. 10, 2004

(51) Int. Cl. H01R 4/60

(52) U.S. Cl. 439/212

(57) ABSTRACT

A blade terminal is provided for an electrical power connector which is mountable on a printed circuit board. The terminal includes at least a pair of flat metal layers juxtaposed to form a laminated structure, with a non-conductive layer disposed between the metal layers. The metal layers include contact blade ends separated from each other a first distance by the non-conductive layer, for mating with one or more appropriate terminals of a complementary connecting device. The metal layers include board mounting ends separated from each other a second distance greater than the first distance, for mounting to the printed circuit board.

### FIELD OF THE INVENTION

This invention generally relates to the art of electrical connectors and, particularly, to a power connector and, still further, to a power connector for mounting on a printed circuit board.

### BACKGROUND OF THE INVENTION

Generally, an electrical connector includes some form of non-conductive or insulative housing which mounts one or more conductive terminals. The housing is configured for mating with a complementary mating connector or other connecting device which, itself, has one or more conductive terminals. A connector assembly typically includes a pair of mating connectors, such as plug and receptacle connectors sometimes called male and female connectors.

Various types of electrical connectors are designed for mounting on a printed circuit board. The terminals have terminating ends for connection to appropriate circuit traces on the board, such as solder tails for solder connection to the circuit traces on the board and/or in holes in the board.

One type of board mounted connector is a power (i.e., versus a signal) connector which mounts one or more power terminals. The power connector couples power circuitry to or from power circuits on the printed circuit board. With the ever-increasing density of electrical components used in electronic packaging, electrical power connectors often are needed to carry high current between a circuit board and a complementary mating connector or other connecting device, or between one circuit board and another circuit board. Power connectors typically are rather robust structures, and a male power connector may include one or more rather sizable terminal blades.

As microprocessor voltages decrease, current requirements have increased, leading to the need for power connectors which can connect electrical currents between multiple electronic devices. The present invention is directed to satisfying this need by a unique blade terminal for a power connector by having a single terminal with two blades to connect currents with two different power requirements while still saving space on the printed circuit board.

### SUMMARY OF THE INVENTION

An object, therefore, of the invention is to provide a new and improved electrical power connector of the character described, particularly a power connector mountable on a printed circuit board.

In the exemplary embodiment of the invention, a blade terminal is provided for an electrical power connector which is mountable on a printed circuit board. The terminal includes at least a pair of flat metal layers juxtaposed to form a laminated structure, with a non-conductive layer disposed between the metal layers. The metal layers include contact blade ends separated from each other a first distance by the non-conductive layer, for mating with one or more appropriate terminals of a complementary connecting device. The metal layers include board mounting ends separated from each other a second distance greater than the first distance, for mounting to the printed circuit board.

According to one aspect of the invention, the metal layers and the non-conductive layer all have generally equal thicknesses. According to another aspect of the invention, the non-conductive layer is adhered to the metal layers to hold the layers together in the laminated structure.

In the preferred embodiment, the mounting end of each metal layer comprises a row of solder tails. Thereby, the two rows of solder tails of the respective metal layers are spaced the second distance from each other.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a top, front perspective view of an electrical power connector embodying the blade terminals of the invention;

FIG. 2 is a front perspective view of a pair of blade terminals mounted in the connector of FIG. 1;

FIG. 3 is a rear perspective view of the pair of terminals, showing how the terminals can interengage with a plurality of mating terminals; and

FIG. 4 is a view similar to that of FIG. 2, but of an alternative embodiment of the invention.

### DETAILED DESCRIPTION OF THE PREFERRED EMBODIMENTS

Referring to the drawings in greater detail, an electrical power connector, generally designated 10, includes a unitary, overmolded housing, generally designated 12. The housing is a one-piece structure which is overmolded about portions of a pair of internal terminals, namely an outer blade terminal, generally designated 14 and an inner blade terminal, generally designated 16. The housing may be molded of non-conductive plastic material.

Housing 12 of connector 10 includes a front mating face 18 and a bottom board-mounting face 20. Mating face 18 defines a receptacle 22 for receiving a mating connector or other connecting device. Board mounting face 20 is provided for mounting on top of a printed circuit board, with a plurality of solder tails 24 from terminals 14 and 16 projecting downwardly from the board-mounting face for insertion into holes in the printed circuit board and for connection, as by soldering, to appropriate power traces on the board and/or in the holes. Therefore, the mating connector is inserted into receptacle 22 in the direction of arrow “A” generally parallel to the circuit board.

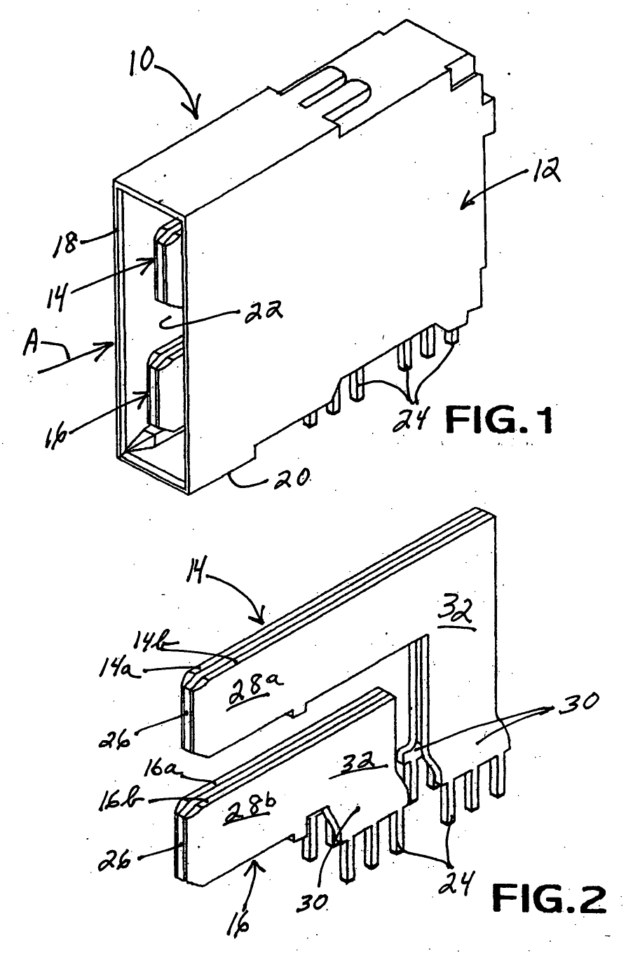

Referring to FIG. 2 in conjunction with FIG. 1, blade terminals 14 and 16 are called “outer” and “inner” terminals, respectively, because outer terminal 14 is generally L-shaped to define an “elbow” within which inner terminal 16 is nested as can be seen in FIG. 2. As will be described below, each terminal is a laminated structure defined by two metal layers separated by a non-conductive layer.

More particularly, outer blade terminal 14 includes a pair of flat metal layers 14a and 14b which form a laminated structure, with a non-conductive layer 26 between the metal layers. Like the overall configuration of the terminal, metal layers 14a and 14b are generally L-shaped. Each metal layer includes a blade end 28a, 28b, a board-mounting end 30 and an L-shaped mounting section 32 between the ends. Board mounting ends 30 are bent outwardly to define two rows of solder tails 24 which project downwardly from bottom edges of the two metal layers which form the laminated terminal. Non-conductive layer 26 is cut to the same shape as the contact blade ends 28a and mounting sections 32 of metal layers 14a and 14b. The non-conductive layer is sandwiched between the metal layers to form the full laminated structure of outer terminal 14.

Non-conductive layer 26 of outer terminal 14 has a thickness approximately the same as the thickness of each metal layer 14a or 14b. Nevertheless, this thickness can be greater or less than the thickness of each metal layer depending upon the thickness needed to prevent occurrences such as arcing and to provide for adequate heat dissipation. In any event, this thickness spreads the metal layers apart a given or first distance. Board mounting ends 30 are bent outwardly to separate the two rows of solder tails from each other a second distance which is greater than the distance that the metal layers are separated by the non-conductive layer. This separation of solder tails will assist in heat dissipation and will reduce the possibility of solder from one solder hole from migrating to another solder hole from a different circuit which migration could create a short circuit.

Inner terminal 16 also has a pair of flat metal layers 16a and 16b to form a laminated structure, with a non-conductive layer 26 between the metal layers. Again, the non-conductive layer is substantially the same thickness as either metal layer. Each metal layer 16a or 16b of inner terminal 16 includes a contact blade end 28b, a board mounting end 30 and a mounting section 32. Like the outer terminal, the board mounting sections 30 of the metal layers of the inner terminal separate the two rows of solder tails 24 from each other a second distance which is greater than the first distance in which metal layers 16a and 16b are separated by non-conductive layer 26. When housing 12 is overmolded about outer and inner terminals 14 and 16, respectively, the plastic material of the overmolded housing covers mounting sections 32 of terminals 14 and 16, leaving contact blade ends 28 exposed within receptacle 22 as seen in FIG. 1. Solder tails 24 also are left exposed at bottom mounting face 20 of the housing, also as seen in FIG. 1.

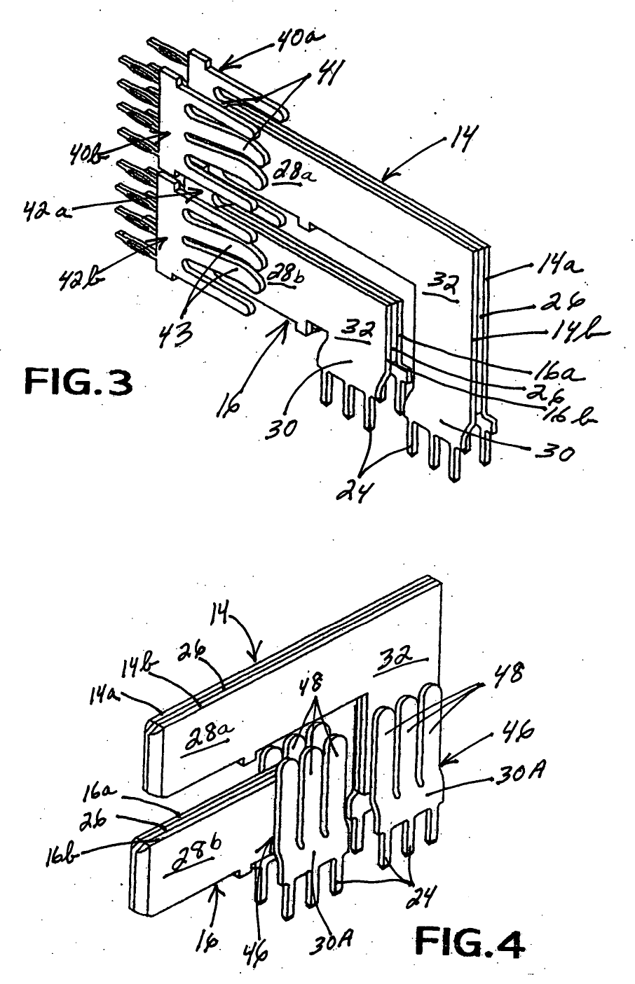

FIG. 3 is a somewhat schematic illustration showing how outer and inner terminals 14 and 16, respectively, without the housing 12 being present, can engage multiple terminals to carry multiple currents from one or more mating connectors. In actual practice, the terminals would be over molded by housing 12 before the terminals engage the terminals of the mating connector. It should be noted that blade ends 28a and 28b can have lengths which begin at a different distance from the front mating face 18 of the housing 12. This can result in a lower insertion force due to the staggered engagement time between the blade ends. Also this staggered arrangement can provide a first make last break contact with ground terminals of a mating connector required in certain applications.

Specifically, the schematic illustration of FIG. 3 shows two upper mating terminals, generally designated 40a and 40b, and two lower mating terminals, generally designated 42a and 42b. Each upper mating terminal includes a plurality of contact fingers 41 and each lower mating terminal includes a plurality of contact fingers 43. One of the upper mating terminals engages only one side of outer blade terminal 14 and, thereby, engages the contact blade end 28 of only one metal layer at each opposite side of blade terminal 14. Specifically, contact fingers 41 of upper mating terminal 40a engage contact blade end 28 of metal layer 14a. Contact fingers 41 of upper mating terminal 40b engage contact blade end 28 of metal layer 14b. Of course, the metal layers are electrically insulated from each other by non-conductive layer 26. Therefore, upper mating terminals 40a and 40b are connected by the two rows of separated solder tails 24 of metal layers 14a and 14b, respectively, of blade terminal 14 to distinct power traces on the printed circuit board.

Similarly, contact fingers 43 of lower mating terminal 42a engage contact blade end 28 of metal layer 16a of inner blade terminal 16. Contact fingers 43 of lower mating terminal 42b engage contact blade end 28 of metal layer 16b of the inner blade terminal. From the foregoing, it can be seen that four mating terminals 40a, 40b, 42a, and 42b are connected by outer and inner terminals 14 and 16, respectively, to the printed circuit board by four distinct sets or rows of solder tails 24. When terminals 14 and 16 are overmolded by housing 12, the rows of solder tails 24 of outer blade terminal 14 align with the two rows of solder tails of inner blade terminal 16 so that there actually are two elongated rows of solder tails, notwithstanding the fact that the solder tails are electrically coupled to four distinct mating terminals.

It is contemplated that non-conductive layers 26 can be used to hold metal layers 14a/14b or 16a/16b together as a unitary laminated structure. This eliminates any type of fastening or extraneous fixing means to hold the respective layers of the respective terminals together.

FIG. 4 shows an alternate embodiment of the invention wherein outer blade terminal 14 and inner blade terminal 16 can be stamped out of flat sheet metal material, without board mounting ends 30 and solder tails 24 as shown in FIG. 2. Separate board-mounting members 46 are welded to opposite sides of the outer and inner blade terminals. The separate board-mounting members have mounting sections 30A which are bent outwardly to spread solder tails 24 according to the second distance which is greater than the distance which the metal layers are separated from each other by non-conductive layers 26. Members 46 have fingers 48 which are welded to the outside faces of the metal layers of blade terminals 14 and 16.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A blade terminal for an electrical power connector mountable on a printed circuit board, comprising:
at least a pair of flat metal layers juxtaposed to form a laminated structure with a non-conductive layer between the metal layers and the metal layers including
contact blade ends separated from each other a first distance by said non-conductive layer for mating with one or more appropriate terminals of a complementary connecting device, and
board mounting ends separated from each other a second distance greater than said first distance for mounting to the printed circuit board.

2. The blade terminal of claim 1 wherein said mounting end of each metal layer comprises a row of solder tails whereby the two rows of solder tails of the respective metal layers are spaced from each other said second distance.

3. The blade terminal of claim 1 wherein said metal layers and non-conductive layer all have generally equal thicknesses.

4. The blade terminal of claim 1 wherein said non-conductive layer is adhered to the metal layers to hold the layers together in said laminated structure.

5. An electrical power connector mountable on a printed circuit board, comprising:
a non-conductive housing having a mating face and a terminating face; and
a terminal mounted in the housing and including
at least a pair of flat metal layers juxtaposed to form a laminated structure with a non-conductive layer between the metal layers and the metal layers including
contact blade ends exposed at the mating face of the housing and separated from each other a first distance by said non-conductive layer for mating with one or more appropriate terminals of a complementary connecting device, and
board mounting ends exposed at the terminating face of the housing and separated from each other a second distance greater than said first distance for mounting to the printed circuit board.

6. The electrical power connector of claim 5 wherein said mounting end of each metal layer comprises a row of solder tails whereby the two rows of solder tails of the respective metal layers are spaced from each other said second distance.

7. The electrical power connector of claim 5 wherein said metal layers and non-conductive layer all have generally equal thicknesses.

8. The electrical power connector of claim 5 wherein said non-conductive layer is adhered to the metal layers to hold the layers together in said laminated structure.

9. The electrical power connector of claim 5 wherein said metal layers include mounting sections between the contact blade ends and the board mounting ends, and said housing is overmolded about said mounting sections.

10. The electrical power connector of claim 1 wherein two pair of flat metal layers are provided, each pair in a plane the same plane as the other pair with one pair nested within the other pair.

11. The electrical power connector of claim 10 wherein the contact blade ends of the one pair of flat metal layers begins at a first distance from the front mating face of the housing and the contact blade ends of the other pair of flat metal layers begins at a second distance from the front mating face of the housing, where the first and second distances are different from one another.
